(19) United States
(12) Patent Application Publication
(10) Pub. No.: US 2003/0045266 A1
(43) Pub. Date: Mar. 6, 2003

(54) Mobile wireless communication devices with airtime accounting and methods therefor

(76) Inventors: Duane J. Staskal, Iowa City, IA (US); Scott J. Healy, New Brighton, MN (US)

Correspondence Address: MOTOROLA INC, 600 NORTH US HIGHWAY 45, LIBERTYVILLE, IL, 60048-5343, US

(21) Appl. No.: 09/924,842

(22) Filed: Aug. 8, 2001

(51) Int. Cl. H04M 11/00

(52) U.S. Cl. 455/405; 455/407; 455/566; 455/567

(57) ABSTRACT

A method in a mobile wireless communications device (300) including determining a communication time remaining, for example by decrementing (210) a communication time limit for communication time used, and providing a user alert (214) at an output (370) of the device before a total communication time used exceeds the communication time limit. In another embodiment, the communication time remaining is automatically reset (205) periodically to the communication time limit, for example in synchronism with a service provider billing statement. In another embodiment, the communication time remaining is indicated (211), for example visually on a display (320) of the device.

### FIELD OF THE INVENTIONS

The present inventions relate generally to mobile wireless communications devices, and more particularly to user airtime accounting features and methods therefor.

### BACKGROUND OF THE INVENTIONS

Telephone call timers are known generally. U.S. Pat. No. 4,079,201 entitled “Electronic Telephone Call Timer” for example discloses a land-line desktop telephone that measures and displays individual and cumulative off-hook call times. U.S. Pat. No. 5,222,127 entitled “Portable Phone” discloses a cellular telephone handset capable of measuring and storing accumulated call times associated with subscriber numbers registered to the handset.

In the communications industry, many service providers offer multi-rate calling plans. Communication service plans for example often charge different rates for calls made during daily business hours than for calls made during evenings and on weekends. Also, many service providers in the competitive wireless communications industry offer fixed fee monthly subscriber plans that include predetermined numbers of peak and off-peak airtime minutes.

Communication service providers often include detailed calling records with monthly invoice statements, but users are generally unaware of the communication time remaining at any particular time of the month.

Existing communication devices are incapable of flexibly accounting for calls made at different hours of the day and according to schedules that coincide with service provider's billing cycles. Although some cellular handsets track total airtime used and provide user resettable call timers, there exists no known device that indicates the communication time remaining, or a device that provides a call remaining indicator synchronized with a communication service plan.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is an exemplary process flow diagram.

FIG. 2 is another exemplary process flow diagram.

FIG. 3 is a schematic block diagram of an exemplary mobile wireless communication device.

### DETAILED DESCRIPTION OF THE INVENTIONS

The inventions are drawn generally to methods for communications accounting in communication devices, for example, mobile wireless communication devices including cellular telephones, two-way pagers, wireless enabled personal digital assistants (PDAs) and wireless enabled portable computers, and programmable telephones, among other devices.

According to one aspect of the invention, one or more communication time intervals are programmed in a communications device for monitoring communications occurring during the one or more time intervals.

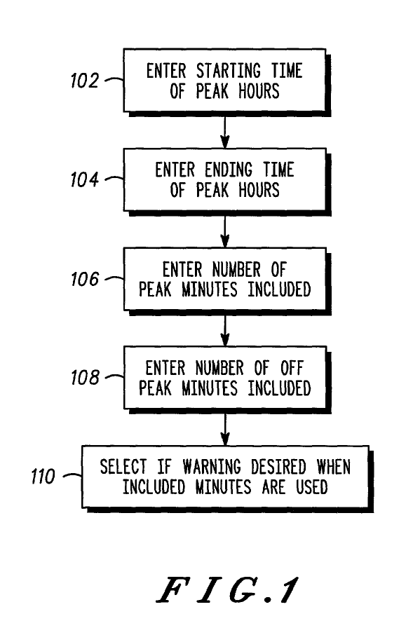

In FIG. 1, for example, a first communication time interval is a “Peak” interval defined by entering a start time at block 102 and entering an ending time at block 104. The order of entry is inconsequential. In one embodiment, the “Peak” interval is less than 24 hours, wherein the balance of the day is a second communication, “Off-Peak”, interval. More generally, any number communication intervals may be programmed into the device.

The time interval may be specified by entering the hour and/or by date, or may be downloaded from the service provider, or may be selected graphically by blocking and selecting portions of a calendar displayed on the communications device.

In the exemplary embodiment, the communication time intervals correspond to different billing rates assessed by the service provider. Some service plans, for example, provide limited amounts of “Peak” and “Off-Peak” airtimes for a fixed fee, for example, “Peak” times maybe during weekday business hours, and “Off-Peak” time may be during evenings and weekends. Thus in the exemplary embodiment of FIG. 1, the “Peak” time interval corresponds to the hours of the day when communication costs are greater than during the other, “Off-Peak” hours of the day. More generally, there may be several time intervals each having a different billing rate. In other embodiments, the time intervals correspond to some other variable besides cost.

According to another aspect of the invention, one or more communication time limits are programmed into the communications device for determining how much communication time remains during a particular time interval under a particular communication service plan. The communication time limit entered may be the airtime provided in a particular service plan, in excess of which the user is assessed a surcharge. A communication time limit is entered generally for one or more time intervals.

In FIG. 1, the number of “Peak” minutes are input or entered at block 106, and a number of “Off-Peak” minutes are entered at block 108. Such a configuration corresponds for example to communication service plans that provide for a limited number of “Peak” and “Off-Peak” minutes.

Plans that provide a specified amount of monthly airtime for a single flat rate without distinguishing between “Peak” and “Off-Peak” times are also common among wireless communication providers. For single rate plans, only a single communication time limit entry is required, and it is not necessary to enter start and end times, or alternatively the start and end times entered are the same.

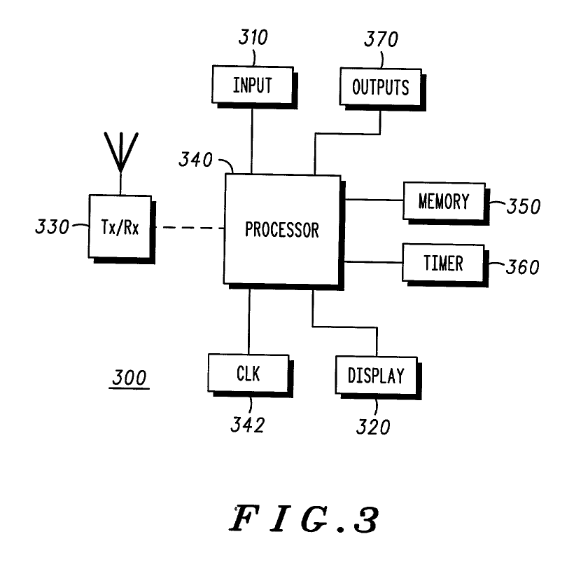

In the block diagram of the communications device 300 of FIG. 3, the one or more communication time intervals and the corresponding time limits may be entered at an input device 310, for example a key pad or some other input device, in response to menu options or items in a configuration mode on a display 320 of the communications device. In embodiments where the communication device is a mobile wireless device, a wireless transmitter/receiver 330 is included.

A communication time remaining determination may be performed at the communications device, for example by a processor 340 or other logic circuitry and a clock 342, for each of the one or more time intervals of interest. The time remaining is determined generally by decrementing a time limit for communication time used during a particular time interval.

In one embodiment, the one or more time limits are stored in memory 350 and communication time used is monitored by the processor and subtracted or decremented from the time limit, resulting in the time remaining, which is also stored. Thereafter, the communication time used is decremented from the stored time remaining to provide an updated time remaining. The decrementing may be performed after each communication, or alternatively it may occur dynamically during communications, for example to alert the user during a communication that the total time used will soon exceed or has exceeded the time limit, as discussed more fully below.

In another embodiment, a counter or timer 360 on the device is initialized with some value corresponding to the time limit, and the counter is decremented in some proportion to the communication time used expended, for example for each minute of air-time used, wherein the time remaining on the counter is indicative of the communication time remaining. Other calculation schemes may be employed alternatively.

Alternatively, the communication time remaining determination may be performed on the communication network, for example by the service provider, wherein the communication time remaining is occasionally transmitted or downloaded to the communications device for display and/or for alerting the user of some condition as discussed further below.

According to a further aspect of the invention, the communication time remaining is indicated at the communication device. Generally, the time remaining is associated with a particular time interval. As discussed, the time remaining indicated may be based on calculations performed at the communications device or based on calculations performed at the network.

In one embodiment, the communication time remaining is indicated visually on a display 320 of the device. Alternatively, the time remaining may be indicated on some other output 370 of the device, for example at an audio output.

Where the time remaining is displayed visually, it may be displayed continuously or in response only to a user input. In embodiments where there are multiple time limits, for example “Peak” and “Off-Peak” limits more than one time indicator may be displayed, simultaneously with identifying indicia. In other embodiments, only the time remaining for a particular time interval is indicated.

According to still another aspect of the invention, an alert, for example an audible and/or tactile indicator, may be generated at the output 370 of the communications device to notify the user that a communication has or is about to exceed a time limit. In another embodiment, a user alert is also generated at the device prior to or when transitioning from one communication time interval to another, for example from off-peak to peak time.

In one embodiment, the generation of the alert is based upon a communication time remaining determination performed at the device, although the network could also signal or prompt the device to generate the alert based on a determination made by the service provider. The alert may be generated, for example, before or when a total communication time of the device exceeds a communication limit for a particular time interval.

In FIG. 1, the alert generator for either or both of these functions is enabled or disabled by the user at block 110, for example by making menu selections or entries in a configuration mode. In one embodiment, the user may specify a warning interval, for example, by specifying that the alert be signaled when only a few minutes of communication time remains, or that the time interval transition alert occur some time prior to the transition.

According to yet another aspect of the invention, the communication time remaining is automatically reset periodically. For example, the periodic reset mat be synchronized with a billing cycle so time remaining is automatically reset back to one or more time limits on the first day of each billing cycle. Where multiple time limits for corresponding time intervals are concerned, the time limits are reset at the appropriate times. The reset time or date may be programmed by the user, for example by entering a numerical date of by selecting a day in a calendar in a configuration mode. The communication time used for a particular billing cycle, stored in memory or as a state in a timer, would also be reset when the time remaining is reset.

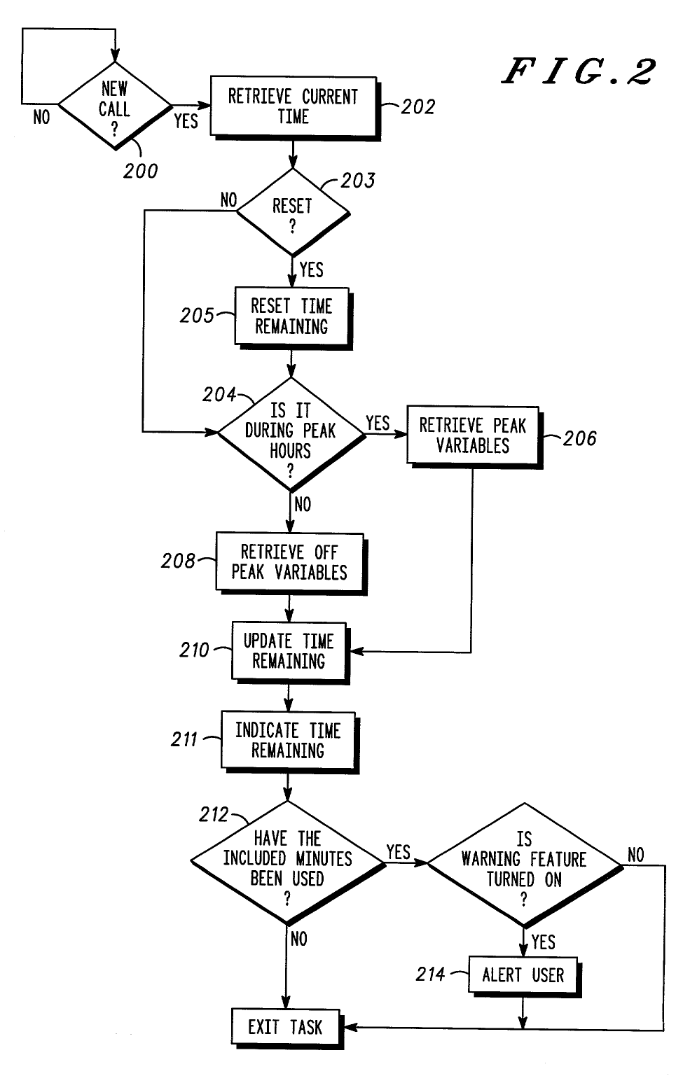

FIG. 2 is an exemplary algorithm for implementing several aspects of the invention in a communications device that operates, for example voice communication and/or a data transmission, in “Peak” and “Off-Peak” communications time intervals at block 200. A “Peak” or “Off-Peak” interval determination is made at decision block 204 based on a time determination made at block 202, for example checking a local time date register or memory location.

At block 203 a determination is made as to whether it is time to reset the time remaining and the total communication time, for example synchronously with a billing statement date, whereupon the reset occurs at block 205.

“Peak” or Off-Peak” variable data, for example the corresponding time remaining information, is retrieved at blocks 206 or 208, respectively, based on the outcome of a decision block 204. At block 210, the time remaining is updated, for example by reducing or decrementing the previous time remaining to account for time expended during a call or other communication. At block 211, the time remaining is indicated at the device, for example on a visual display.

At block 212, a determination is made as to whether any communication time remains, or whether the time remaining is within an alert threshold. If affirmed, and if the alert feature is enabled, as determined at block 213, the user is signaled at block 214.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A method in a mobile wireless communications device, comprising:
programming a first and second communication time limits for corresponding first and second communication time intervals in the mobile wireless communications device;
determining a first communication time remaining in the first time interval by decrementing the first communication time limit for communication time used in the first time interval;
determining a second communication time remaining outside the first time interval by decrementing the second communication time limit for communication time used outside the first time interval.

2. The method of claim 1, displaying on the mobile wireless communications device the first communication time remaining, displaying on the mobile wireless communications device the second communication time remaining.

3. The method of claim 2, generating a user alert at the mobile wireless communications device before a first total communication time used in the first time interval exceeds the first communication time limit.

4. The method of claim 1, automatically resetting the first communication time remaining to the first communication time limit periodically, automatically resetting the second communication time remaining to the second communication time limit periodically.

5. A method in a mobile wireless communications device, comprising:
determining a communication time remaining by decrementing a communication time limit for communication time used by the mobile wireless communications device;
providing a user alert at the mobile wireless communications device before a total communication time used by the mobile wireless communications device exceeds the communication time limit.

6. The method of claim 5, indicating at the mobile wireless communications device the communication time remaining.

7. The method of claim 6, indicating the communication time remaining by displaying the communication time remaining on a display of the mobile wireless communications device.

8. The method of claim 5, automatically resetting the communication time remaining to the communication time limit periodically, automatically resetting the total communication time used periodically.

9. The method of claim 5, providing the user alert on the mobile wireless communications device by generating at least one of an audible and tactile signal.

10. A method in a mobile wireless communications device, comprising:
determining a communication time remaining based on a difference between a communication time limit mobile wireless communications device and communication time used by the mobile wireless communications device;
indicating at the mobile wireless communications device the communication time remaining;
automatically resetting the communication time remaining to the communication time limit periodically.

11. The method of claim 10, indicating the communication time remaining by displaying the communication time remaining on the mobile wireless communications device.

12. The method of claim 10, providing a user alert at the mobile wireless communications device before a total communication time used by the mobile wireless communications device exceeds the communication time limit.

13. A method in a communications device, comprising:
indicating at the communications device a first communication time remaining based on a difference between a first communication time used and first communication time limit in a first time interval;
indicating at the communications device a second communication time remaining based on a difference between a second communication time used and the second communication time limit in a second time interval.

14. The method of claim 13,
programming the first and second communication time limits for the corresponding first and second time intervals in the mobile wireless communications device;
determining the first and second communication times remaining at the mobile wireless communications device.

15. The method of claim 13, automatically resetting the first communication time remaining to the first communication time limit and automatically resetting the second communication time remaining to the second time limit periodically.

16. The method of claim 13, indicating the first and second communication times remaining by displaying the first and second communications time remaining on a display of the communications device.

17. The method of claim 13, generating a user alert at the communications device before a first total time of communications used in the first time interval exceeds the first communication time limit.

18. The method of claim 13, generating a user alert at the communications device not later than when transitioning between the first and second time intervals.
